(19) United States
(12) Patent Application Publication
(10) Pub. No.: US 2026/0245014 A1
(43) Pub. Date: Aug. 20, 2026

(54) SHORTEST PATH BEHAVIOR IN AUTOMATION AGENTS

(71) Applicant: GDM Holding LLC, Mountain View, CA (US)

(72) Inventors: Florian Nils Hartmann, Zurich (CH); Sian Heather Gooding, London (GB)

(21) Appl. No.: 19/057,825

(22) Filed: Feb. 19, 2025

(51) Int. Cl. G06Q 10/0631; G06N 20/00

(52) U.S. Cl. CPC G06Q 10/06316; G06N 20/00

(57) ABSTRACT

Methods, systems, and apparatus for shortest path behavior in automation agents. In one aspect, an automation agent associated with a user device receives an automation task from a user. The automation agent iteratively executes actions in a sequence of actions that is responsive to the automation task, where each action modifies a state of the user device. At each iteration, candidate actions are determined based on a starting state of the user device as of the iteration. A cost associated with each candidate action is estimated, where the cost represents a computational resource consumption cost of performing a candidate action when the user device is in the starting state as of the iteration. A candidate action with a lowest estimated cost is selected. The selected candidate action is executed to modify the starting state of the user device as of the iteration.

### BACKGROUND

This specification generally relates to automation of tasks using generative neural networks.

Automation refers to the process of using artificial intelligence to perform tasks or execute commands on behalf of a user without requiring manual intervention. The tasks can range from straightforward actions such as setting reminders or sending messages, to more complex operations such as navigating software interfaces or extracting information from documents or applications.

### SUMMARY

This specification describes systems and methods for shortest path behavior in automation agents.

In general, one innovative aspect of the subject matter described in this specification may be embodied in methods that include the actions of receiving, by an automation agent associated with a user device, an automation task from a user; iteratively executing, by the automation agent, actions in a sequence of actions that is responsive to the automation task, wherein each action modifies a state of the user device and iteratively executing the actions comprises, at each iteration and until the automation task is completed: determining, based on a starting state of the user device as of the iteration, one or more candidate actions; estimating, for each of the one or more candidate actions, a cost associated with the candidate action, wherein the cost represents a computational resource consumption cost of performing the candidate action when the user device is in the starting state as of the iteration; selecting a candidate action with a lowest estimated cost; and executing the selected candidate action to modify the starting state of the user device as of the iteration.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus (e.g., one or more computers or computer processors), cause the apparatus to perform the actions.

The foregoing and other embodiments can each optionally include one or more of the following features, alone or in combination. In some implementations the cost associated with the candidate action is further dependent on a likelihood that the selected candidate action is an incorrect next action in the sequence of actions.

In some implementations the computational resource consumption cost comprises a measure of an expected latency of performing the candidate action when the user device is in the starting state as of the iteration or a measure of an expected amount of network bandwidth required to perform the candidate action when the user device is in the starting as of the iteration or both.

In some implementations the candidate action with the lowest estimated cost is selected from a queue of candidate actions, the queue comprising candidate actions determined for the iteration and one or more candidate actions determined during a previous iteration.

In some implementations the method further comprises, for each candidate action determined during a previous iteration: estimating a cost associated with navigating from a starting state of the user device for the iteration to a starting state of the user device for the previous iteration; and updating the estimated cost associated with the candidate action to include the estimated cost associated with navigating from the starting state of the user device for the iteration to the starting state of the user device for the previous iteration.

In some implementations the selected candidate action comprises a candidate action determined during a previous iteration, and wherein executing the selected candidate action comprises navigating to the starting state of the user device for the previous iteration and executing the selected candidate action from the starting state of the user device for the previous iteration.

In some implementations the method further comprises, at one or more iterations: selecting a plurality of candidate actions with lowest estimated costs; and executing the selected candidate actions in parallel.

In some implementations the automation agent has been trained offline to estimate the costs associated with candidate actions.

In some implementations the method further comprises training the automation agent to estimate costs associated with candidate actions online, the training comprising: generating training data using sequences of actions executed by the automation agent in response to receiving respective automation tasks; and training the automation agent to estimate costs associated with candidate actions using the training data.

In some implementations estimating the cost associated with the candidate action comprises extracting contextual information associated with the candidate action. In some implementations the contextual information comprises an estimated media download time.

In some implementations the method further comprises estimating, for each of the one or more candidate actions, a cost of completing the automation task when the candidate action is executed, wherein selecting the candidate action with the lowest estimated cost comprises selecting the candidate action based on the costs associated with the one or more candidate actions and the costs associated with completing the automation task when the one or more candidate actions are executed.

In some implementations estimating the cost of completing the automation task when the candidate action is executed comprises computing a similarity between a state of the user device obtained after the candidate action is executed and a target state of the user device associated with completion of the automation task.

In some implementations the method further comprises generating training data, comprising iteratively determining and executing, by the automation agent, actions in a respective sequence of actions that is responsive each of multiple automation tasks; and training, using the training data, the automation agent to determine and execute sequences of actions that accurately complete respective input automation tasks.

In some implementations the state of the user device as of the iteration comprises an operating state of the user device or a state of an application running on the user device.

In some implementations the state of the user device as of the iteration is represented by a screen displayed by the user device as of the iteration.

In some implementations the method further comprises receiving, by the automation agent, a second automation task from the user; determining, by the automation agent and historical data associated with previously received automation tasks, whether to perform the iterative executing of candidate actions in a sequence of candidate actions that is responsive to the second automation task; and in response to determining to perform the iterative executing of candidate actions in a sequence of actions that is responsive to the second automation task, performing the iterative executing until the second automation task is completed.

In some implementations the method further comprises receiving, by the automation agent, a second automation task from the user; determining, by the automation agent and historical data associated with previously received automation tasks, whether to perform the iterative executing of candidate actions in a sequence of candidate actions that is responsive to the second automation task; and in response to determining not to perform the iterative executing of candidate actions in a sequence of actions that is responsive to the second automation task, directly executing a sequence of actions that completes the second automation task.

Some implementations of the subject matter described herein may realize, in certain instances, one or more of the following advantages.

To complete an automation task, the automation agent interacts with user device and applications (e.g., settings or messaging apps), websites (e.g., the ones of airlines) and outside tools (e.g., airline APIs). Each action that the automation agent performs has an associated computational resource consumption cost, e.g., delay. Since a sequence of actions is typically required to complete an automation task, the computational resource consumption costs can become significant. Further, if the automation agent does not pick the correct action at each step, the user needs to wait longer for the automation task to be completed, and the automation agent in turn requires more model inference and compute. This increase in computational resource consumption only becomes more significant as automation agents are expected to be able to handle more and more complex, and also longer-term, tasks.

Unlike standard automation agents that are only trained to select best next actions in a sequence of actions to complete an automation task, the presently described systems and methods configure the automation agent to consider the shortest path to complete the automation task. The shortest path is a path that optimizes one or more computational resource consumption costs including, e.g., user waiting time, computational runtime, memory usage, battery consumption, CPU utilization, GPU usage, security requirements, or network usage. Shortest path logic, e.g., Dijkstra or A* logic, is distilled into the automation agent to teach the agent to determine a shortest path by considering various candidate paths in parallel. Accordingly, the computational resource consumption costs required to complete the automation task are reduced.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a conceptual diagram of an automation agent that uses shortest paths to complete automation tasks.

FIG. 2 is a block diagram of an example automation agent system.

FIG. 3 is a block diagram of the automation agent system of FIG. 2 during an example inference process for completing an automation task.

FIG. 4 is a block diagram of the automation agent system of FIG. 2 during an example training process.

FIG. 5 is a flow chart of an example process for completing an automation task.

FIG. 6 is a flow chart of an example process for implementing shortest path logic to solve an automation task at inference and during training.

Like reference symbols in the various drawings indicate like elements.

### DETAILED DESCRIPTION

This specification describes systems and methods for incorporating shortest path behavior in automation agents. During inference, an automation agent iteratively executes actions in a sequence of actions to complete an automation task. At each iteration, the automation agent determines possible actions that could be performed from a user device starting state for the iteration, and estimates computational resource consumption costs associated with each possible action. The lowest cost action is selected and executed to update the user device starting state for the iteration. A training dataset of training examples that include an automation task and corresponding shortest path sequence of actions that completes the automation task can be collected during inference, and used to distill the shortest path behavior into the model, e.g., train the automation agent to directly determine shortest path sequences of actions.

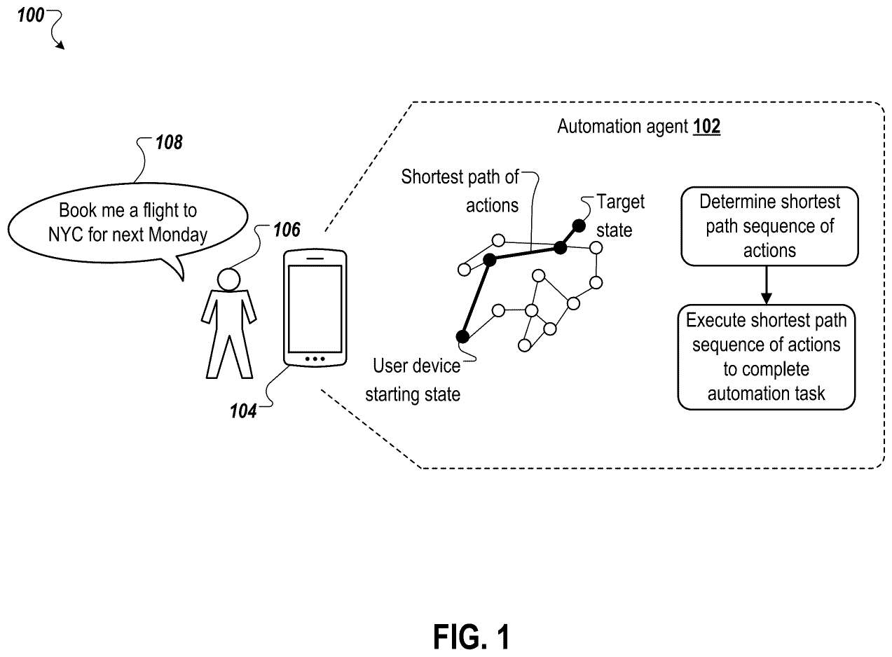

FIG. 1 is a conceptual diagram 100 of an automation agent that uses shortest paths to complete automation tasks. An automation agent 102 operates on a user device 104. A user 106 of the user device 104 queries the automation agent 102 with an automation task 108. Example automation tasks include “put my phone into airplane mode,” “text John that I'm running late,” and “book me a flight to NYC next Monday.” In response to receiving the automation task, the automation agent 102 performs a sequence of actions that completes the automation task. Each action is an operation performed by the automation agent 102 that updates an operating state of the user device 104, e.g., changes content displayed by the user device 104, changes applications running on the user device, changes user device settings, etc. For example, to put the phone into airplane mode, the sequence of actions could include selecting a home button to display a home screen on the user device, swiping downwards from a top corner of the home screen, and selecting the airplane mode toggle to put the phone into the airplane mode.

To perform the actions in the sequence of actions, the automation agent 102 interacts with one or more of: the user device, applications installed on the user device, websites, or outside tools such as APIs.

Each action that the automation agent 102 performs has some associated computational resource consumption cost. Since completion of the automation task requires a sequence of actions to be performed, the overall computational resource consumption cost required to complete the automation task can become significant due to each additional step causing an additional cost to be incurred. Further, if the automation agent 102 does not select a correct or best action at any given step in the sequence of actions, the computational resource consumption cost required to complete the automation task can increase, since the number of actions in the sequence of actions can increase. In turn, the automation agent 102 then requires more model inference and compute. This will only become more problematic in the future as automation agents learn to handle more complex and longer-term tasks.

To address this problem, the presently described automation agent 102 is configured to consider the shortest path of actions required to complete the automation task. Since multiple paths of actions could be used to complete the automation task, shortest path logic is distilled into the automation agent 102. In some implementations the shortest path logic can include Dijkstra logic, which determines a shortest path from a single source node to all other nodes in a weighted graph, where nodes with a lowest cumulative cost are prioritized using a greedy approach. In other implementations the shortest path logic can include A* logic, which iteratively determines a shortest path from a single source node to a target node based on a cost of the path taken so far and a heuristic estimate of the remaining cost (to reach the target node). This enables the agent to determine the shortest path sequence of actions by considering multiple candidate actions in parallel.

In some cases the shortest path can be defined as a path or sequence of actions that minimizes waiting time. However, alternatively or in addition, the shortest path can also be defined for one or more other computational resource consumption costs including, e.g., memory usage, battery consumption, CPU utilization, GPU usage, security requirements, or network usage. In some cases the computational resource consumption costs used to define the shortest path can be dynamically chosen based on the current context. For example, in cases that the automation agent runs on-device (e.g., there is no API cost) and the device is a desktop computer (e.g., there is no battery issue) that is connected to a WiFi network (e.g., it is unlikely to be paying per byte uploaded) then the shortest path can be defined as a path that minimizes the time spent to complete the automation task. As another example, in cases where the user 106 is about to board a flight and the user device 104 will lose network connectivity, the shortest path could primarily be defined in terms of latency so that automation tasks are more likely to be completed before boarding. As another example, in cases where the user device 104 has low battery and/or does not have access to charging facilities, the shortest path could primarily be defined in terms of battery consumption. In some implementations the user 106 can specify the definition of the shortest path. In other implementations the definition of the shortest path can be determined in advance, e.g., by a developer of the automation agent. In other implementations the automation agent can be configured to perform chain of thought reasoning and dynamically select a definition of the shortest path.

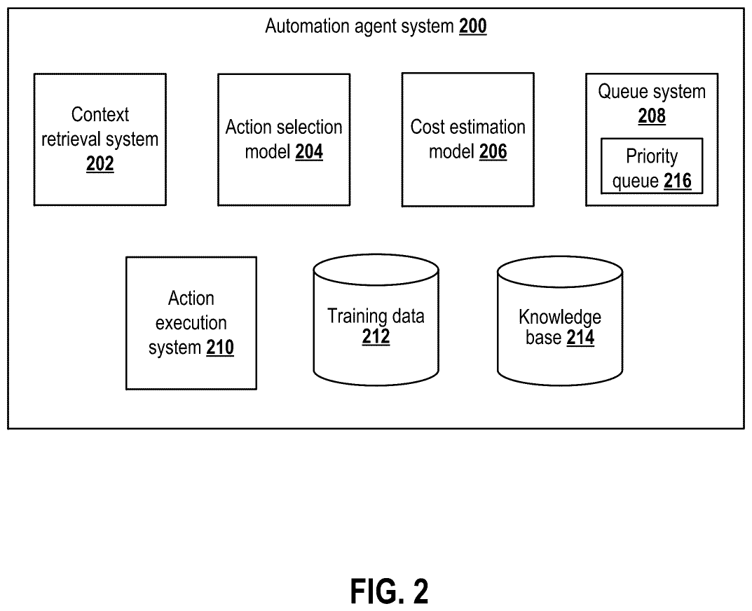

FIG. 2 is a block diagram of an example automation agent system 200. The example automation agent system 200 is an example of a system implemented as computer programs on one or more computers in one or more locations, in which the systems, components, and techniques described herein can be implemented.

The example automation agent system 200 includes a context retrieval system 202, an action selection model 204, a cost estimation model 206, a queue system 208, an action execution system 210, a training data store 212, and a knowledge base 214. The components included in the example automation agent system 200 can be connected via a network (e.g., a local area network (LAN), wide area network (WLAN), the Internet, or a combination thereof, which can be accessed over a wired and/or a wireless communications link) or implemented on a single user device.

The context retrieval system 202 is configured to access screen information of a user device associated with the automation agent system 200 and determine a starting state of the user device. The starting state of the user device is an operating state of the user device and/or a state of an application running on the user device, e.g., at the time an automation task is initially received or after an action in a sequence of actions that completes the automation task has been executed. For example, the context retrieval system 202 can be configured to query the operating system of the user device to access screen content that identifies, e.g., a currently active application, open browsers, or visible GUI elements. In other implementations, the context retrieval system 202 can be configured to obtain a screenshot of the user device and analyze the screenshot to obtain the screen content. The context retrieval system 202 can use obtained screen content to determine the starting state of the user device, e.g., which applications are currently active and what is currently displayed on the user device.

The action selection model 204 is configured to receive an automation task and a starting state of the user device. The starting state of the user device can be provided to the action selection model 204 as a screenshot of the current screen displayed by the user device, an underlying HTML/XML representation of the current screen, or a list of descriptions of selectable elements displayed on the current screen, The action selection model 204 processes the automation task and starting state of the user device to generate an output that specifies possible next actions (referred to herein as candidate actions) that could be performed when the user device is in the starting state, where each candidate action is part of a respective path of actions that completes the automation task.

For example, in cases where the automation task is a request to send a message to a user contact and the starting state of the user device shows that the user device currently displays the home screen, the action selection model 204 could generate an output that specifies possible next actions include: swiping across the home screen (e.g., with a view to locating an icon of a messaging application that can be opened and used to send the message), swiping up from the bottom of the home screen (e.g., with a view to opening an application drawer that displays open applications or recently open applications so that the messaging application can be selected and opened), or typing a name of the messaging application in a search bar currently displayed on the home screen (e.g., with a view to opening the messaging application).

In some implementations, the action selection model 204 can be a generative neural network that is configured, through training, to generate candidate actions that can be performed on the starting state of the user device. For example, the action selection model 204 can be an auto-regressive neural network when the action selection model 204 auto-regressively generates an output sequence of tokens as the network output. More specifically, the auto-regressively generated output is created by generating each particular token in the output sequence conditioned on a current input sequence that includes an input sequence included in the network input and any tokens that precede the particular token in the output sequence, i.e., the tokens that have already been generated for any previous positions in the output sequence that precede the particular position of the particular token.

As a particular example, the action selection model 204 can have any of a variety of Transformer-based neural network architectures, e.g., encoder-only Transformer architectures, encoder-decoder Transformer architectures, decoder-only Transformer architectures, diffusion Transformer architectures, other attention-based architectures, and so on.

Examples of such Transformer-based neural network architectures include those described in Colin Raffel, et al., Exploring the limits of transfer learning with a unified text-to-text transformer. arXiv preprint arXiv:1910.10683, 2019; Daniel Adiwardana, et al., Towards a human-like open-domain chatbot. CoRR, abs/2001.09977, 2020; Aakanksha Chowdhery, et al., PaLM: Scaling Language Modeling with Pathways, arXiv preprint arXiv:2204.02311; Rohan Anil, et al., Palm 2 technical report. arXiv preprint arXiv:2305.10403, 2023; and Gemini Team, et al., Gemini: a family of highly capable multimodal models. arXiv preprint arXiv:2312.11805 (2023).

For example, the action selection model 204 may be a generative language mode neural network. Examples of generative language model neural networks include Sparrow (Glaese, et al., arXiv:2209.14375), Chinchilla (Hoffmann, et al., arXiv:2203.15556), and PaLM 2 (Anil, et al., arXiv:2305:10403).

As another example, the action selection model 204 may be a foundation model neural network. A foundation model neural network is a large-scale machine learning model trained on a broad data set that can be adapted and fine-tuned for a wide variety of applications and downstream tasks. Examples of foundation model neural networks include Imagen (Saharia, et al., arXiv: 2205.11487) and Parti (Yu, et al., arXiv: 2206.10789).

The action selection model 204 can include an input block, followed by one or more intermediate blocks, followed by an output block. The input block can receive an input to the student neural network.

The input block can include an embedding layer. The embedding layer includes parameters that represent elements of an embedding matrix which can be used to map each token in the vocabulary of tokens into a corresponding embedding of the token.

The one or more intermediate blocks can include one or more attention blocks, e.g., one or more local attention blocks, one or more global attention blocks, or both. A local attention block is a block that includes a local attention mechanism, while a global attention block is a block that includes a global attention mechanism.

The output block can generate an output of the action selection model 204. For example, the output can include a score distribution, e.g., a probability distribution, over tokens in a vocabulary of tokens. The score distribution assigns a respective score, e.g., a respective probability, to each token in the vocabulary of tokens.

The output block can include a de-embedding layer. The de-embedding layer includes parameters that represent elements of a de-embedding matrix which can be used to map an embedding to a corresponding token in the vocabulary of tokens. In some implementations, the de-embedding matrix can be a transpose of the embedding matrix included in the input block, such that each parameter of the de-embedding matrix has a corresponding parameter in the embedding matrix.

The vocabulary of tokens can include any of a variety of tokens that represent text symbols or other symbols. For example, the vocabulary of tokens can include one or more of: characters, sub-words, words, punctuation marks, numbers, or other symbols that appear in a corpus of natural language text and/or computer code.

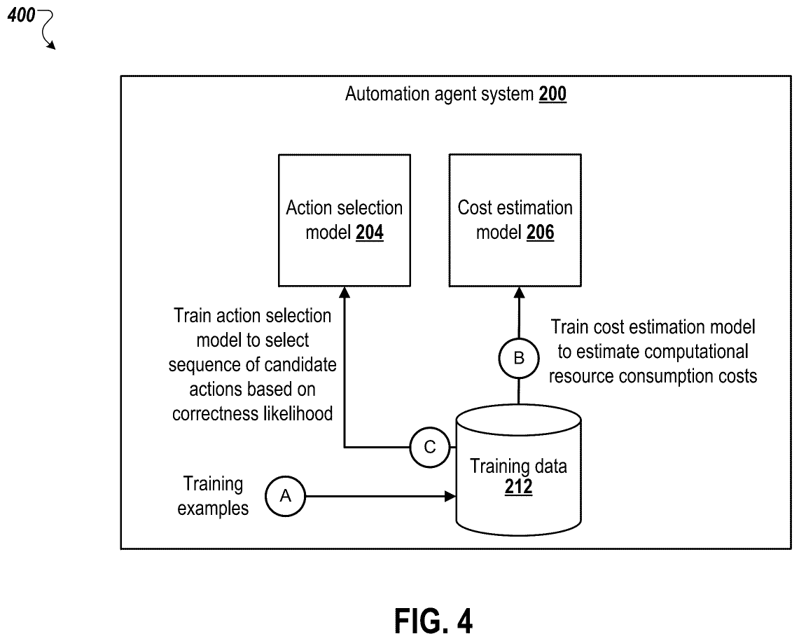

In some implementations the action selection model 204 can be trained by fine-tuning a pre-trained model. Training the action selection model 204 to generate candidate actions is described below with reference to FIG. 4.

The cost estimation model 206 is configured to receive the starting state of the user device and the candidate actions determined by the action selection model 204. The cost estimation model 206 is configured to estimate a cost associated with each candidate action. The cost represents a computational resource consumption cost of performing the candidate action when the user device is in the starting state. For example, the computational resource consumption cost can represent a waiting time associated with executing the candidate action when the user device is in the starting state. Other example computational resource consumption costs include network bandwidth, memory usage, battery consumption, CPU utilization, GPU usage, security requirements, or network dependency. In some implementations, the cost can also be dependent on a correctness likelihood, e.g., a likelihood that the candidate action is a next best action and will ultimately lead to an accurate completion of the automation task. In some implementations the cost can be a weighted combination of one or more computational resource consumption costs and/or a correctness likelihood.

In some implementations the cost estimation model 206 is a machine learning model that is configured, through training, to estimate costs associated with respective candidate actions. For example, the cost estimation model 206 can be a transformer based model. Generally, the cost estimation model 206 is configured to obtain as input a current screen on the user device, a description of a candidate action (e.g., coordinates of a button to click), and the goal of the automation task. The cost estimation model 206 processes the input to output an estimation of the cost of the candidate action.

Training the cost estimation model 206 to estimate costs associated with respective candidate actions is described below with reference to FIG. 4. Alternatively or in addition, the cost estimation model 206 can be configured to use contextual information of the user device starting state to estimate costs associated with respective candidate actions. For example, in some cases the starting state of the user device can provide an indication that enables a cost to be estimated with high accuracy, e.g., if an application provides a precise estimated download time of a media item. As another example, in some cases candidate action can be associated with a known fixed cost, e.g., SMS text messages typically have a fixed size limit so the data usage associated with sending a SMS under the fixed size is fixed. In these implementations, the cost estimation model 206 can use the indicated or fixed cost as the estimated cost. In some cases the indicated or fixed cost can be used as an initial estimated cost that is subsequently refined by a machine learning model.

The queue system 208 is configured to maintain a priority queue 216 of candidate actions generated by the action selection model 204 and respective costs associated with the candidate actions as estimated by the cost estimation model 206. The queue system 208 is configured to insert each candidate action into the priority queue 216 as a data triple that includes the candidate action, a user device starting state for the candidate action, and the estimated cost of performing the candidate action. The queue system 208 is configured to order the triples in the priority queue 216 based on the estimated costs, e.g., so that candidate actions with lower costs have a higher priority than candidate actions with higher costs. The queue system 208 is configured to provide one or more candidate actions with lowest costs to the action execution system 210.

The action execution system 210 is configured to execute the candidate actions obtained from the queue system 208. For example, the action execution system 210 can translate the candidate actions to corresponding low-level commands or instructions that the user device can execute, e.g., by matching the candidate actions to predefined executable commands or routines. The action execution system 210 can then execute the low-level commands or instructions by interacting with relevant user device hardware or software components, e.g., by making API calls or interacting with databases or user interfaces.

The training data store 212 is configured to store training examples generated by the automation agent system 200 during inference, e.g., when the system determines a sequence of lowest cost candidate actions that complete an automation task. The training examples stored in the training data store 212 can be used to train the action selection model 204 and/or the cost estimation model 206, as described below with reference to FIG. 4.

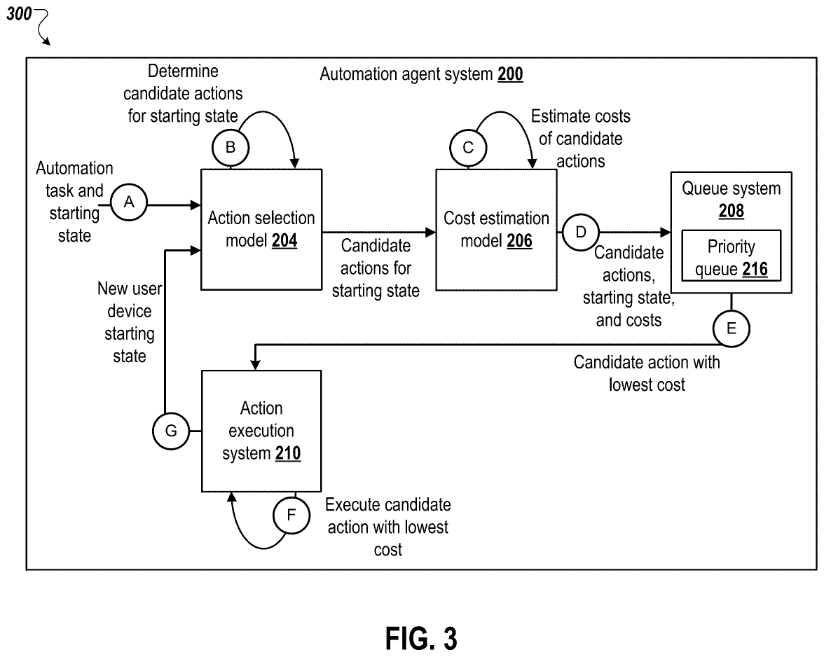

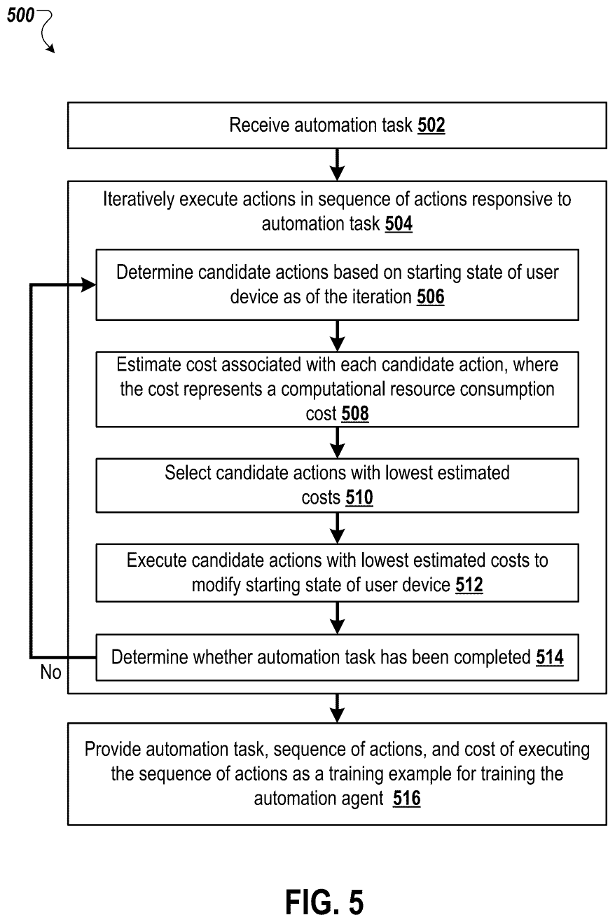

The knowledge base 214 stores historical data relating to previously received automation tasks, e.g., determined sequences of candidate actions and associated costs of the sequences of candidate actions, performance metrics related to completing previous automation tasks, and user preferences, e.g., application usage preferences, preferred privacy or security settings, computational consumption cost preferences, or location based preferences. The automation agent system 200 is configured to use the knowledge base 214 to support decision making and task execution during inference. For example, in some implementations, when the automation agent system 200 receives an automation task from a user, the automation agent system 200 can run a chain of thought reflection using the knowledge base 214 to determine whether to perform direct inference to directly use the action selection model 204 to determine a sequence of actions that completes the automation task, or to implement shortest path logic to determine a sequence of actions that completes the automation task, as described below with reference to FIGS. 3 and 5.

FIG. 3 is a block diagram 300 of the automation agent system 200 of FIG. 2 during an example inference process for completing an automation task. The block diagram 300 illustrates the example process as including stages (A)-(G). However, in some implementations the process can include fewer or more stages.

During stage (A) of the example inference process, the automation agent system 200 obtains an automation task. In some implementations, the automation task can be received from a user of a user device associated with the automation agent system 200. In other implementations, the automation task can be a task from an automation dataset used for training purposes, as described below with reference to FIG. 4. During stage (A), the automation agent system 200 also obtains a state of a user device at the time the automation task was obtained (the starting state of the user device), e.g., from the context retrieval system 202.

During stage (B) of the example inference process, the action selection model 204 determines candidate actions that are responsive to the automation ask and updates the starting state of the user device. Initially, the candidate actions are first candidate actions in respective sequences of actions that can be executed to complete the automation task. For example, in cases where the automation task is a request to put the user device in airplane mode and the starting state of the user device shows that the user device currently displays the home screen, the action selection model 202 could determine candidate actions that include: swiping across the home screen (e.g., with a view to locating an icon of a settings application that can be opened and used to set the device to airplane mode) or swiping down from a top corner of the home screen (e.g., with a view to opening a control center that displays commonly used settings and controls, such as an airplane mode toggle). The action selection model 204 provides the candidate actions to the cost estimation model 206.

During stage (C) of the example inference process, the cost estimation model 206 estimates a cost associated with each candidate action determined during stage (B). As discussed above, the cost associated with a respective candidate action represents one or more computational resource consumption costs of performing the candidate action when the user device is in the starting state. For example, the cost can be a weighted combination of the one or more computational resource consumption costs and/or a correctness likelihood. In some implementations, the cost associated with each candidate action can be context-dependent and vary. For example, in implementations where the user device is in a battery saving mode, the cost can include (or prioritize, e.g., by adjusting weights of the costs in the weighted combination) battery consumption to maximize the battery life of the user device. As another example, in implementations where the user device has limited network connectivity, e.g., a slow connection speed, low signal strength, or unstable connection, the cost can include (or prioritize) network dependency and network bandwidth, so that actions that can be executed offline are prioritized and the required amount of data transfer is reduced. In other implementations a user can specify computational resource costs to include or prioritize. In other implementations, the automation agent system may be allocated a budget, e.g., how much the system can spend on LLM APIs per day or how many MB of network traffic the phone has available. If the automation agent system determines that the budget is approaching its maximum allocation, the automation agent system can determine to be more economical in the respective cost measure.

In some implementations, during stage (C), the cost estimation model 206 can implement A* shortest path logic and determine a shortest path based on costs associated with the candidate actions determined during stage (B) and estimated future costs. In these implementations, the cost estimation model 206 further estimates respective expected costs of completing the automation task when each candidate action determined during stage (B) is executed. For example, the cost estimation model 206 can compute a similarity between a (predicted) state of the user device obtained after a candidate action is executed and a target state of the user device associated with completion of the automation task. In some implementations the similarity can be computed based on a distance between embeddings or pixels of the states of the user device. The cost estimation model 206 can use the computed similarity to estimate an expected cost of completing the automation task (where a higher similarity indicates a smaller expected cost of completing the automation task). The expected cost of completing the automation task when the candidate action is executed can then be added to the cost associated with performing the candidate action.

During stage (D) of the example inference process, triples that include the starting state of the user device, a respective candidate action as determined by the action selection model 204 during stage (B), and a respective estimated cost associated with the candidate action as determined by the cost estimation model 206 during stage (C) are provided to the queue system 208 and stored in a priority queue 216.

During stage (E) of the example inference process, the queue system 208 identifies a candidate action with a lowest estimated cost in the priority queue 216. The queue system 208 provides the candidate action with the lowest estimated cost to the action execution system 210. During stage (F), the action execution system 210 executes the candidate action with the lowest cost. Execution of the candidate action with the lowest cost updates the starting state of the user device, e.g., displays a subsequent page of application icons, opens an application, or selects a GUI element. In some cases, the update of the starting state of the user device completes the automation task. In these cases, the automation agent system 200 can be configured to output a notification or indication that the automation task is complete, e.g., a push notification or pop-up message.

In other cases, one or more subsequent actions may be required to complete the automation task. Therefore, during stage (G), the action execution system 210 (or the context retrieval system) can provide the action selection model 204 with a new starting state of the user device, i.e., a state of the user device after the candidate action with the lowest cost has been executed. The automation agent system 200 can then perform subsequent iterations of stages (B)-(G) using respective updated starting states for the iterations until the automation task is complete.

In subsequent iterations of stages (B)-(G), during stage (D), new triples that include a starting state of the user device as of the subsequent iteration, a respective candidate action, and a respective estimated cost associated with the candidate action are stored in the priority queue 208. In some implementations, the new triples can replace previously added triples (triples generated during previous iterations). In other implementations, the new triples can be added to the priority queue. That is, the priority queue can maintain triples for multiple iterations. In these implementations, during stage (E), the identified candidate action with a lowest cost may have a different user device starting state than the current user device starting state, e.g., if the candidate action with the lowest cost is an action that was added to the priority queue 216 in a previous iteration. In these cases, the cost estimation model 206 can be used to determine the cost of navigating to the different user device starting state before the lowest cost candidate action is executed. This additional cost can then be added to the cost associated with the candidate action. Then, during stage (F), the action execution system 210 can navigate from the current user device starting state to the different user device starting state and then execute the candidate action with the lowest cost.

In some implementations, during stage (E) of the example inference process, the queue system 206 can identify multiple candidate actions with lowest estimated costs in the priority queue 208. The queue system 206 can then provide the multiple lowest cost candidate actions to the action execution system 210. During stage (F), the action execution system 210 can execute each lowest cost candidate action in parallel to generate respective updated starting states of the user device. Subsequent iterations of stages (B)-(G) can then be performed for one or more of the respective updated starting states in parallel. For example, if the automation task is a request to book a flight, the multiple lowest cost candidate actions could include opening different travel websites. In this example, the automation agent system 200 could open multiple different travel websites on respective browser tabs and perform actions within each browser tab with the goal of booking the flight, where the actions are terminated when one of the browser tabs completes the automation task and books a flight. The number of lowest cost candidate actions that are selected from the priority queue 208 and executed in parallel can be context-dependent and vary. For example, the number of lowest cost candidate actions to be executed in parallel can depend on one or more of: a predetermined maximum parallelization threshold that specifies a threshold number of actions that can be efficiently performed in parallel, available system resources such as CPU, memory, and bandwidth usage, or a predetermined minimum system performance threshold.

FIG. 4 is a block diagram 400 of the automation agent system 200 of FIG. 2 during an example training process. The block diagram 400 illustrates the example training process as including stages (A)-(C). However, in some implementations the process can include fewer or more stages. Further, the block diagram 400 illustrates stage (B) as preceding stage (C), however, in some implementations stage (C) can precede stage (B), or stages (B) and (C) can be performed approximately in parallel.

During stage (A) of the example training process, training examples are collected and stored in a training data store 212. In some implementations, the training examples can be collected during inference, e.g., during the example process for completing an automation task as described above with reference to FIG. 3. For example, each time the automation agent system 200 completes an automation task according to the example process described above, the automation task and sequence of candidate actions that completed the automation task can be added to the training data store 212 as a training example. Each training example can include an input automation task and starting state, a sequence of candidate actions that were executed to complete the automation task from the starting state, and costs associated with executing each action in the sequence.

During stage (B) of the example training process, the training examples stored in the training data store 212 can be used to train (or fine-tune) the cost estimation model 206 to estimate costs associated with respective candidate actions. For example, the training examples stored in the training data store 212 can be used to generate a labelled dataset, where each input in the dataset includes a respective action and the corresponding output is a known cost of executing the action. The cost estimation model 206 can then be trained (or fine-tuned) on the labelled dataset to minimize an error between predicted costs and the known costs using an objective function, e.g., a mean squared error or mean absolute error.

In some implementations, the cost estimation model 206 can be trained offline. For example, the automation agent system 200 can collect training examples during inference on an automation dataset of automation queries then train the cost estimation model 206 on the training examples before the automation agent system is deployed. Alternatively or in addition, the cost estimation model 206 can be trained online, e.g., on batches of training examples in the training data store 212 as they become available.

During stage (C) of the example training process, the training examples stored in the training data store 212 can be used to train the action selection model 204. By construction, the example inference process described above with reference to FIG. 3 determines a sequence of candidate actions that optimizes the computational resource consumption cost of executing the sequence of candidate actions. For example, when the computational resource consumption cost is waiting time, the determined sequence of candidate actions corresponds to a shortest path from the starting state of the user device at the time the automation task is received to a target state of the user device at a time that the automation task is complete. This inference process is computationally more intensive compared to, e.g., processes that only incorporate a correctness likelihood when determining a best sequence of actions that complete an automation task. However, by training the action selection model 204 on the training examples stored in the training data store 212, the action selection model 204 can be trained to directly follow the optimal sequences of actions (shortest paths) using a less intensive process, e.g., a process that only incorporates a correctness likelihood when determining a best sequence of actions that complete an automation task. That is, the inference process can be used to produce improved training data that distills computational resource consumption cost optimization behavior directly into the automation agent system. Therefore, once the action selection model 204 has been trained on the training examples stored in the training data store 212, the automation agent system 200 can perform direct inference and complete subsequently received automation tasks using only the trained action selection model 204 (and not implement shortest path logic via the cost estimation model 206 and queue system 208).

FIG. 5 is a flow chart of an example process 500 for completing an automation task. For convenience, the process 500 will be described as being performed by a system of one or more computers located in one or more locations. For example, an automation agent system associated with a user device, e.g., the automation agent system 200 of FIG. 2, appropriately programmed, can perform example process 500.

The system receives an automation task (step 502). The system then iteratively executes actions in a sequence of actions that is responsive to the automation task, where each action modifies a state of the user device (step 504). The iterations are performed until the automation task is completed.

At each iteration, the system performs the following operations. The system determines one or more candidate actions based on a starting state of the user device as of the iteration (step 506). The starting state of the user device as of the iteration is an operating state of the user device as of the iteration or a state of an application running on the user device as of the iteration, e.g., represented by a screen displayed by the user device as of the iteration. In a first iteration, the starting state of the user device is the operating state of the user device or state of the application running on the user device at the time the automation task was received. In subsequent iterations, the starting state of the user device is the operating state of the user device or state of the application running on the user device after a previous action in the sequence of actions was executed. The one or more candidate actions include possible actions that can be performed from the starting state of the user device as of the iteration.

The system estimates a cost associated with each of the one or more candidate actions (step 508). The cost represents a computational resource consumption cost of performing the candidate action when the user device is in the starting state as of the iteration. For example, the computational resource consumption cost can include a measure of an expected latency of performing the candidate action when the user device is in the starting state as of the iteration or a measure of an expected amount of network bandwidth required to perform the candidate action when the user device is in the starting as of the iteration or both. Further example computational resource consumption costs include memory usage, battery consumption, CPU utilization, GPU usage, security requirements, or network dependency.

In some implementations the cost associated with the candidate action is further dependent on a likelihood that the selected candidate action is an incorrect next action in the sequence of actions. Further, in some implementations the cost associated with the candidate action can also include an expected cost of completing the automation task when the candidate action is executed. In these implementations, the system can determine the expected cost of completing the automation task when the candidate action is executed by computing a similarity between a state of the user device obtained after the candidate action is executed and a target state of the user device associated with completion of the automation task.

In some implementations, the system can include a machine learning model that has been trained offline to estimate the costs associated with the one or more candidate actions. Alternatively or in addition, the system can extract contextual information associated with the candidate action, e.g., based on the starting state of the user device as of the iteration, and use the contextual information to estimate the cost of the candidate action.

The system selects a candidate action with a lowest estimated cost (step 510) and executes the selected candidate action to modify the starting state of the user device as of the iteration (step 512). In some implementations the system can select multiple candidate actions with lowest estimated costs at step 510, then execute the multiple candidate actions with lowest estimated costs in parallel to obtain multiple modified starting states of the user device, e.g., to open multiple browser tabs. That is, in some implementations the system can process multiple sequences of actions that are each responsive to the automation task in parallel, until a first sequence of actions of the multiple sequences of actions completes the automation task.

In some implementations the system can select the candidate action with the lowest estimated cost from a queue of candidate actions, where the queue includes candidate actions determined for the current iteration and candidate actions determined during one or more previous iterations. In these implementations, a cost associated with a candidate action that was determined during a previous iteration can be an updated cost that includes an estimated cost associated with navigating from the starting state of the user device for the current iteration to the starting state of the user device for the previous iteration. Further, in implementations where the selected candidate action with the lowest estimated cost is a candidate action that was determined during a previous iteration, executing the selected candidate action includes navigating to the starting state of the user device for the previous iteration and executing the selected candidate action from the starting state of the user device for the previous iteration.

The system determines whether execution of the selected candidate action at step 512 completes the automation task or not (step 514). In response to determining that execution of the selected candidate action does not complete the automation task, the system performs a subsequent iteration of steps 506-514 using the modified starting state of the user device as a starting state of the user device as of the iteration. In some implementations, in response to determining that execution of the selected candidate action completes the automation task, the system can provide the user device with an indication, e.g., notification, that the automation task has been completed.

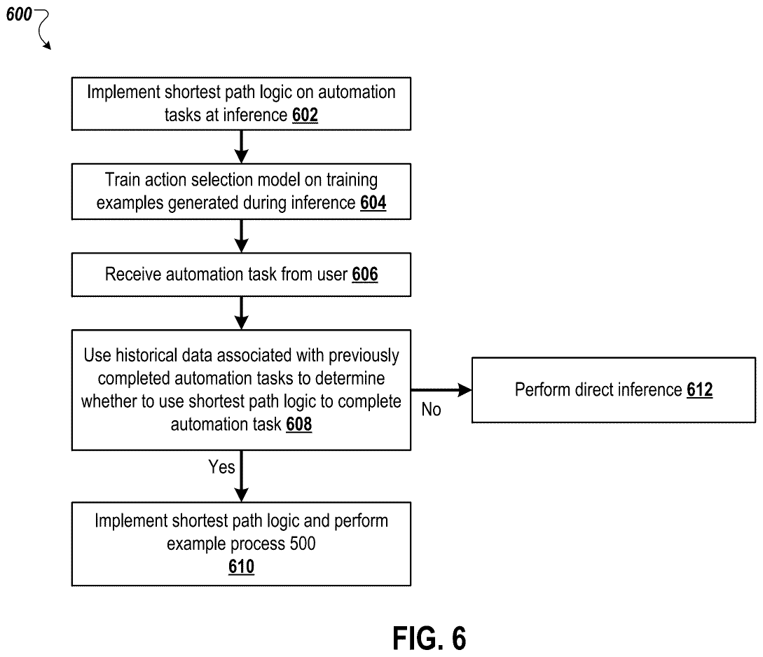

In some implementations the system stores the automation task received at step 502, the sequence of actions iteratively executed at step 504, and a cost of executing the sequence of actions as a training example in a training dataset of multiple training examples that correspond to respective automation tasks that were completed using example process 500. The training examples in the training dataset can then be used to train components of the automation agent system, as described above with reference to FIG. 4, e.g., to distill shortest path logic in an action selection model included in the system. The distillation of shortest path logic is particularly useful when the shortest path logic can be performed internally by the action selection model, e.g., after the action selection model has been trained on training examples generated during inference. However, in some cases this may not be feasible, e.g., if a dynamic or larger amount of reasoning is required to find a shortest path sequence of actions. In these implementations, the system can run a hybrid approach that implements shortest path logic at inference and through training, as described below with reference to FIG. 6.

FIG. 6 is a flow chart of an example process 600 for implementing shortest path logic to solve an automation task at inference and during training. For convenience, the process 600 will be described as being performed by a system of one or more computers located in one or more locations. For example, an automation agent system, e.g., the automation agent system 200 of FIG. 2, appropriately programmed, can perform example process 600.

The system implements shortest path logic on multiple automation tasks at inference (step 602). For example, the system can perform example process 500 of FIG. 5 on multiple automation tasks to generate a training dataset of training examples. The system trains an action selection model to directly determine sequences of actions that are responsive to respective input automation tasks on the training examples in the training dataset (step 604).

The system then receives an automation task from a user (step 606). The system uses historical data associated with previously received automation tasks, e.g., stored in a knowledge base, to run a chain of thought reflection and determine whether to use shortest path logic to complete the automation task or not (i.e., whether to perform example process 500 of FIG. 5 to complete the automation task or not) (step 608). In some implementations, the system can run the chain of thought reflection in response to receiving a prompt that indicates that the system should start a chain of thought. The system can be trained to use a chain of thought reflection, e.g., by incorporating the use of chain of thought reflection in the training dataset. In response to determining to implement shortest path logic to complete the automation task, the system performs example process 500 of FIG. 5 to complete the automation task (step 610). In response to determining not to implement shortest path logic to complete the automation task, the system performs direct inference, e.g., using the trained action selection model, and directly executes a sequence of actions that completes the automation task (612).

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer implemented method comprising:
receiving, by an automation agent associated with a user device, an automation task from a user;
iteratively executing, by the automation agent, actions in a sequence of actions that is responsive to the automation task, wherein each action modifies a state of the user device and iteratively executing the actions comprises, at each iteration and until the automation task is completed:
determining, based on a starting state of the user device as of the iteration, one or more candidate actions;
estimating, for each of the one or more candidate actions, a cost associated with the candidate action, wherein the cost represents a computational resource consumption cost of performing the candidate action when the user device is in the starting state as of the iteration;
selecting a candidate action with a lowest estimated cost; and
executing the selected candidate action to modify the starting state of the user device as of the iteration.

2. The method of claim 1, wherein the cost associated with the candidate action is further dependent on a likelihood that the selected candidate action is an incorrect next action in the sequence of actions.

3. The method of claim 1, wherein the computational resource consumption cost comprises a measure of an expected latency of performing the candidate action when the user device is in the starting state as of the iteration or a measure of an expected amount of network bandwidth required to perform the candidate action when the user device is in the starting state as of the iteration or both.

4. The method of claim 1, wherein the candidate action with the lowest estimated cost is selected from a queue of candidate actions, the queue comprising candidate actions determined for the iteration and one or more candidate actions determined during a previous iteration.

5. The method of claim 4, wherein the method further comprises, for each candidate action determined during a previous iteration:
estimating a cost associated with navigating from a starting state of the user device for the iteration to a starting state of the user device for the previous iteration; and
updating the estimated cost associated with the candidate action to include the estimated cost associated with navigating from the starting state of the user device for the iteration to the starting state of the user device for the previous iteration.

6. The method of claim 5, wherein the selected candidate action comprises a candidate action determined during a previous iteration, and wherein executing the selected candidate action comprises navigating to the starting state of the user device for the previous iteration and executing the selected candidate action from the starting state of the user device for the previous iteration.

7. The method of claim 1, further comprising, at one or more iterations:
selecting a plurality of candidate actions with lowest estimated costs; and
executing the selected candidate actions in parallel.

8. The method of claim 1, wherein the automation agent has been trained offline to estimate the costs associated with candidate actions.

9. The method of claim 1, further comprising training the automation agent to estimate costs associated with candidate actions online, the training comprising:
generating training data using sequences of actions executed by the automation agent in response to receiving respective automation tasks; and
training the automation agent to estimate costs associated with candidate actions using the training data.

10. The method of claim 1, wherein estimating the cost associated with the candidate action comprises extracting contextual information associated with the candidate action.

11. The method of claim 10, wherein the contextual information comprises an estimated media download time.

12. The method of claim 1, further comprising:
estimating, for each of the one or more candidate actions, a cost of completing the automation task when the candidate action is executed,
wherein selecting the candidate action with the lowest estimated cost comprises selecting the candidate action based on the costs associated with the one or more candidate actions and the costs associated with completing the automation task when the one or more candidate actions are executed.

13. The method of claim 12, wherein estimating the cost of completing the automation task when the candidate action is executed comprises computing a similarity between a state of the user device obtained after the candidate action is executed and a target state of the user device associated with completion of the automation task.

14. The method of claim 1, further comprising:
generating training data, comprising iteratively determining and executing, by the automation agent, actions in a respective sequence of actions that is responsive each of multiple automation tasks; and
training, using the training data, the automation agent to determine and execute sequences of actions that accurately complete respective input automation tasks.

15. The method of claim 1, wherein the state of the user device as of the iteration comprises an operating state of the user device or a state of an application running on the user device.

16. The method of claim 1, wherein the state of the user device as of the iteration is represented by a screen displayed by the user device as of the iteration.

17. The method of claim 1, further comprising:
receiving, by the automation agent, a second automation task from the user;
determining, by the automation agent and historical data associated with previously received automation tasks, whether to perform the iterative executing of candidate actions in a sequence of candidate actions that is responsive to the second automation task; and
in response to determining to perform the iterative executing of candidate actions in a sequence of actions that is responsive to the second automation task, performing the iterative executing until the second automation task is completed.

18. The method of claim 1, further comprising:
receiving, by the automation agent, a second automation task from the user;
determining, by the automation agent and historical data associated with previously received automation tasks, whether to perform the iterative executing of candidate actions in a sequence of candidate actions that is responsive to the second automation task; and
in response to determining not to perform the iterative executing of candidate actions in a sequence of actions that is responsive to the second automation task, directly executing a sequence of actions that completes the second automation task.

19. A system comprising one or more computers and one or more storage devices storing instructions that are operable, when executed by the one or more computers, to cause the one or more computers to perform operations comprising:
receiving, by an automation agent associated with a user device, an automation task from a user;
iteratively executing, by the automation agent, actions in a sequence of actions that is responsive to the automation task, wherein each action modifies a state of the user device and iteratively executing the actions comprises, at each iteration and until the automation task is completed:
determining, based on a starting state of the user device as of the iteration, one or more candidate actions;
estimating, for each of the one or more candidate actions, a cost associated with the candidate action, wherein the cost represents a computational resource consumption cost of performing the candidate action when the user device is in the starting state as of the iteration;
selecting a candidate action with a lowest estimated cost; and
executing the selected candidate action to modify the starting state of the user device as of the iteration.

20. One or more computer storage media encoded with instructions that, when executed by one or more computers, cause the one or more computers to perform operations comprising:
receiving, by an automation agent associated with a user device, an automation task from a user;
iteratively executing, by the automation agent, actions in a sequence of actions that is responsive to the automation task, wherein each action modifies a state of the user device and iteratively executing the actions comprises, at each iteration and until the automation task is completed:
determining, based on a starting state of the user device as of the iteration, one or more candidate actions;
estimating, for each of the one or more candidate actions, a cost associated with the candidate action, wherein the cost represents a computational resource consumption cost of performing the candidate action when the user device is in the starting state as of the iteration;
selecting a candidate action with a lowest estimated cost; and
executing the selected candidate action to modify the starting state of the user device as of the iteration.
